(19) United States
(12) Patent Application Publication
(10) Pub. No.: US 2017/0177863 A1
(43) Pub. Date: Jun. 22, 2017

(54) Device, System, and Method for Detecting Malicious Software in Unallocated Memory

(71) Applicant: Wind River Systems, Inc., Alameda, CA (US)

(72) Inventor: Arlen BAKER, Alameda, CA (US)

(21) Appl. No.: 14/971,290

(22) Filed: Dec. 16, 2015

(51) Int. Cl. G06F 21/56; G06F 21/60; H04L 9/06

(52) U.S. Cl. CPC G06F 21/56; H04L 9/0643; G06F 21/602

(57) ABSTRACT

A device, system, and method detects a malicious module using a memory of an electronic device. The method performed by an electronic device includes generating a first parameter corresponding to first unallocated regions of the memory in a trusted state, wherein the memory in the trusted state includes at least one memory allocation, each memory allocation corresponding to a module or an action previously determined as trusted. The method includes generating a second parameter corresponding to second unallocated regions of the memory in a current state, wherein the memory in the current state corresponds to a subsequent allocation of the memory at a time subsequent to the trusted state. The method includes comparing the second parameter to the first parameter. The method includes indicating that the malicious module is detected in the second unallocated regions if the comparing step determines that the second parameter is different from the first parameter.

### BACKGROUND INFORMATION

An electronic device may include a processor that executes a variety of different types of computer-executable instructions from various programs, applications, modules, etc., to perform various functionalities. The electronic device may further include storage components, such as, a disk drive that enables data to be stored in a general manner, and a Random Access Memory (RAM) that enables the computer-executable instructions to request an allocation of the RAM for temporary use while the computer-executable instructions are being executed. For example, the computer-executable instructions may require temporary storage of some amount of data during execution of the instructions. As the need arises, the computer-executable instructions may dynamically request allocation of a portion or chunk of memory from the RAM. This dynamic request for RAM allocation may be implemented as a call to a function, which itself may be defined by one or more lines within the computer-executable instructions or code forming a computer module. Furthermore, while the computer-executable instructions are executed, there may be a plurality of calls to this dynamic request for RAM allocation or to similar memory application programming interface functions from the computer-executable instructions that requested the allocation of RAM. In addition, further computer-executable instructions may be executed concurrently that may also request the allocation of RAM.

The electronic device may be subject to malicious attacks that installs malicious software. That is, the computer-executable instructions that are executed by the processor may encompass the intended instructions or intended modules, such as, for example, the operating system (OS) and associated actions of the OS, but may also include unintended instructions, such as, for example, those from malicious software (malware), and/or associated actions of the malicious software. Those skilled in the art will understand that the malicious software may operate in a manner that is unknown to the user and may utilize whatever resources available on the electronic device. With respect to the RAM, the malicious software may operate in a substantially similar manner as the intended instructions in that portions or chunks of the RAM may be requested by the malicious software using a call function. Because the RAM is a limited resource, the malicious software consumes and/or otherwise renders unavailable the RAM that would otherwise be utilized by intended instructions and thereby creating a poor user experience, such as, e.g., slower processing speeds. The malicious software may also be configured to circumvent the ordinary memory allocation procedure and reside in portions of the RAM that have not been allocated through normal memory allocation services.

The electronic device may be configured with mechanisms that detect whether malicious software has been installed and utilizing the memory, e.g., RAM. A plurality of different approaches may be used in performing this detection functionality. One approach is to detect changes in the RAM. Specifically, the approach detects changes in the allocated portions of the memory. For example, an identity of the module that performed the call for a computer-executable instruction to be allocated a portion of the memory, e.g., RAM, may indicate whether the module is or contains malicious software. However, the malicious software may also reside in unallocated portions of the memory, e.g., RAM, because the malicious software may have bypass normal memory allocation services and accessed unallocated portions of the memory. Accordingly, existing mechanisms for detecting malicious software in allocated portions of the memory cannot detect the malicious software residing in unallocated portions of the memory.

### SUMMARY

The exemplary embodiments are directed to a method for detection of a malicious module using a memory of an electronic device, comprising: generating, by the electronic device, a first parameter corresponding to first unallocated regions of the memory in a trusted state, wherein the memory in the trusted state includes at least one memory allocation, each memory allocation corresponding to a module or an action previously determined as trusted; generating, by the electronic device, a second parameter corresponding to second unallocated regions of the memory in a current state, wherein the memory in the current state corresponds to a subsequent allocation of the memory at a time subsequent to the trusted state; comparing, by the electronic device, the second parameter to the first parameter; and indicating that the malicious module is detected in the second unallocated regions if the comparing step determines that the second parameter is different from the first parameter.

The exemplary embodiments are directed to an electronic device, comprising: a memory including first unallocated regions in a trusted state and second unallocated regions in a current state, the trusted state including at least one memory allocation, each memory allocation corresponding to a module or an action previously determined as trusted, the current state being at a time subsequent to the trusted state; and a processor generating a first parameter corresponding to the first unallocated regions, the processor generating a second parameter corresponding to the second unallocated regions, the processor comparing the second parameter to the first parameter, the processor indicating that the malicious module is detected in the second unallocated regions if the comparing step determines that the second parameter is different from the first parameter.

The exemplary embodiments are directed to a non-transitory computer readable storage medium with an executable program stored thereon, wherein the program instructs a microprocessor to perform operations comprising: generating a first parameter corresponding to first unallocated regions of a memory in a trusted state, wherein the memory in the trusted state includes at least one memory allocation, each memory allocation corresponding to a module or an action previously determined as trusted; generating a second parameter corresponding to second unallocated regions of the memory in a current state, wherein the memory in the current state corresponds to a subsequent allocation of the memory at a time subsequent to the trusted state; comparing the second parameter to the first parameter; and indicating that the malicious module is detected in the second unallocated regions if the comparing step determines that the second parameter is different from the first parameter.

### BRIEF DESCRIPTION OF THE DRAWINGS

FIG. 1 shows an electronic device according to the exemplary embodiments.

FIG. 2A shows a first memory surface according to the exemplary embodiments.

FIG. 2B shows a second memory surface according to the exemplary embodiments.

FIG. 3 shows a method for detecting malicious software in unallocated memory according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, a system, and a method for detecting malicious software through analyzing unallocated portions of a memory. Specifically, the exemplary embodiments relate to a Random Access Memory (RAM) of a storage arrangement that may be used by computer-executable instructions of one or more modules executed by a processor of an electronic device. The computer-executable instructions may allocate certain portions or regions of the memory, e.g., RAM, to the computer-executable instructions, and leaving as a remainder unallocated regions of the memory, e.g., RAM. The exemplary embodiments provide a mechanism that is configured to analyze the unallocated regions of the memory, e.g., RAM, to detect whether any malicious software is present.

The exemplary embodiments provide a mechanism in which a service of an operating system (OS) that allocates memory is modified to load computer-executable instructions into any suitable form of memory, e.g., RAM, to track the regions of the memory, e.g., RAM, that are not allocated by a memory allocation service or function into a memory allocation table. Specifically, the memory allocation table may be a scatter/gather table that tracks unallocated regions of the memory, e.g., RAM, for example, using a representation of the RAM, such as, for example, a memory surface. The memory allocation table may be used to compute a digest. The digest may be computed at any suitable time, for example, the digest may be computed at a determined time or may be computed periodically at predetermined time intervals. A most recently computed digest may be used to compare to a previously generated sealed digest, as will be discussed further below. The comparison may be used to detect changes to the unallocated regions of the memory surface, which may be indicative of malicious software.

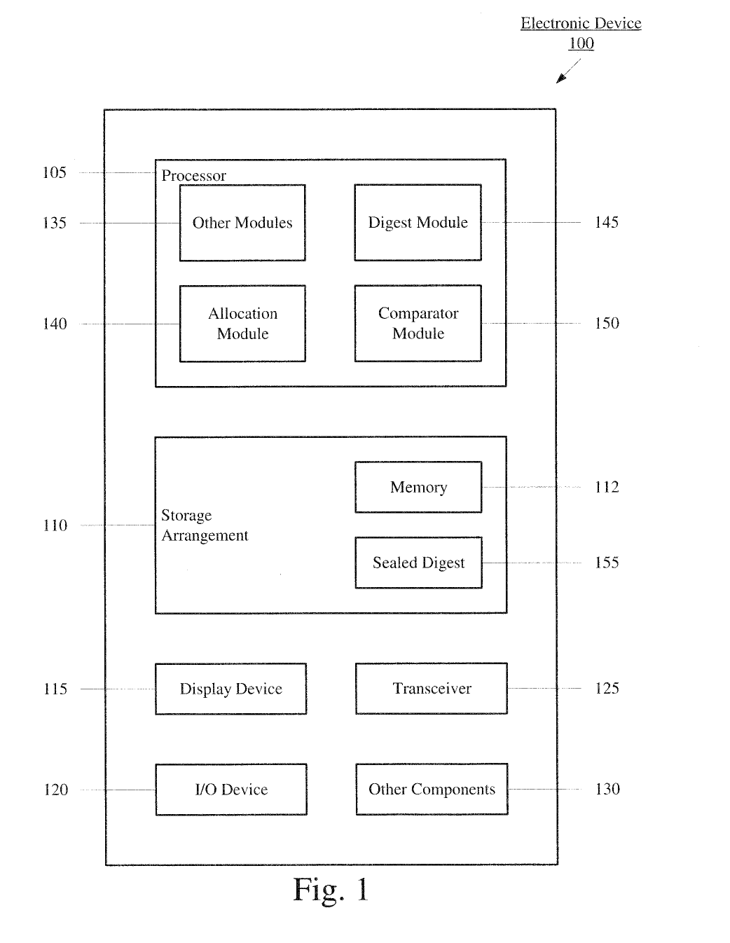

FIG. 1 shows components of an electronic device 100 according to the exemplary embodiments. The electronic device 100 may be configured to execute at least one module and computer-executable instructions thereof, and determine whether any malicious software is present on the electronic device 100. As will be described in further detail below, the presence of malicious software on the electronic device 100 may be detected by evaluating the unallocated portions of the memory of the electronic device 100. The electronic device 100 may represent any electronic device such as, for example, a portable device (e.g., a cellular phone, a smartphone, a tablet, a phablet, a laptop, a wearable, etc.) or a stationary device (e.g., desktop computer). The electronic device 100 may include a processor 105 and a storage arrangement 110 that includes a memory 112. The electronic device 100 may further optionally include one or more of the following: a display device 115, an input/output (I/O) device 120, a transceiver 125, and other suitable components 130, such as, for example, a portable power supply, an audio I/O device, a data acquisition device, ports to electrically connect the electronic device 100 to other electronic devices, etc.

The processor 105 may be configured to execute computer-executable instructions from a plurality of modules that provide various functionalities to the electronic device 100. For example, the plurality of modules may include an allocation module 140, a digest module 145, and a comparator module 150. As will be described in further detail below, the allocation module 140 may provide functionalities associated with a call in which a portion or region of the memory 112 are allocated to one of the modules; the digest module 145 may generate a sealed digest (or a sealed parameter) representing a memory surface of allocated and unallocated regions in a trusted state and a digest (or a further parameter) representing the memory surface in a current state; and the comparator module 150 may detect malicious software based upon performing comparisons of sealed digests to digests. In further examples, the plurality of modules may also include one or more other modules 135. The other modules 135 may include an OS, a web browser that enables the user to retrieve information while connected to a network via the transceiver 125, communication modules (e.g., a short messaging service (SMS) module, an email module, voice and/or video communication modules, etc.), etc.

It should be noted that the applications executed by the processor 105 are only exemplary. In a first example, the processor 105 may be an applications processor. In another example, the functionalities described for the modules may also be represented as a separately incorporated component of the electronic device 100 (e.g., an integrated circuit with or without firmware), or may be a modular component coupled to the electronic device 100. The functionality or functionalities may also be distributed throughout multiple components of the electronic device 100.

It should also be noted that the functionalities described herein for the digest module 145 and the comparator module 150 being executed by the processor 105 are only exemplary. According to another exemplary embodiment, the functionalities performed by the digest module 145 and the comparator module 150 may be carried out or executed by a processing unit external to processor 105 or external to the electronic device 100, for example, a separate external process or a different electronic device. The digest module 145 may receive all memory allocation information from and/or generated by the allocation module 140. In particular, the digest module 145 may receive, for example, memory allocation information specific to the memory 112. The digest module 145 may utilize the information received from the allocation module 140 to generate the digests, which may be subsequently provided to the comparator module 150 to provide the features of the exemplary embodiments, e.g., detect presence or absence of malicious software within the electronic device 100, more particularly, within the storage arrangement 110.

The storage arrangement 110 may be a hardware component configured to store data related to operations performed by the electronic device 100. The storage arrangement 110 may include one or more storage components configured to store the data. In a first example, the storage arrangement 110 may include a general data storage component such as a disk drive. In a second example, the storage arrangement 110 may include a processing storage component (also referred herein as “memory” 112), such as, for example, a Random Access Memory (RAM). Those skilled in the art will understand that the disk drive may provide a large storage capacity to which data may be written, and to which data may remain stored even when power is disconnected from the disk drive. For example, the disk drive may utilize magnetic features to store this data on disks. However, use of the disk drive is relatively slow as data thereon needs to be located, read, and transmitted to the appropriate component before this data can be processed. In contrast, the memory 112 provides a series of hardware components, for example, computer chips, that loads data from the various modules such as the other modules 135 (including any OS) which may be retrieved near instantaneously. However, any loss in power results in data stored in the memory 112 to be lost. Furthermore, the memory 112 has a lesser storage capacity. Thus, regions of the memory 112 that is allocated to an application is typically allocated on a temporary basis.

The display device 115 may be a hardware component configured to provide to a user a visual representation corresponding to the data. The I/O device 120 may be a hardware component configured to receive inputs from the user and output corresponding data. For example, the display device 115 may show results of the digest module 145 (e.g., the sealed digest) and/or the comparator module 150. The transceiver 125 may enable the connection between the electronic device 100 and another electronic device. Specifically, when the functionalities of the digest module 145 and/or the comparator module 150 are performed on an external processor or device, e.g., a further electronic device, the transceiver 125 may enable a wired or wireless connection with the further electronic device directly or indirectly such as via a network so that the information between the electronic device 100 and an external processor or device may be exchanged.

As discussed above, the processor 105 may execute the other modules 135, the allocation module 140, the digest module 145, and/or the comparator module 150 to detect malicious software that may have inadvertently been installed and/or loaded on the electronic device 100. Again, the other modules 135 may represent any suitable module that includes computer-executable instructions for operation of the electronic device 100, including, for example an OS, a web browser, a word processing application, etc. The OS may include a plurality of services and functionalities, such as the functionalities associated with the allocation module 140. The allocation module 140 may receive requests or calls from modules to allocate regions of the memory 112. In response to such requests or calls, the allocation module 140 may allocate regions in the memory 112 for the requesting module. The digest module 145 may generate a sealed digest and/or a digest of a memory surface of the memory 112 that corresponds to unallocated regions within the memory 112. The comparator module 150 may perform a comparison of a sealed digest to a current digest to determine changes to the unallocated regions of the memory 112 and utilize information from the allocation module 140 to detect a presence or absence of malicious software in the memory 112.

It should be noted that the exemplary embodiments relate to allocated regions and unallocated regions on the memory 112 and an analysis on the unallocated regions on the memory 112. However, the exemplary embodiments relating to the memory 112 is only exemplary. The exemplary embodiments may also be used for the storage arrangement 110, such as a disk drive portion or a portion of a disk drive in which regions may be occupied by data. Accordingly, use of the memory 112, as described with respect to the exemplary embodiments, may also be representative of a mechanism that may be modified for use with the storage arrangement 110.

A module may include a plurality of commands, actions, functionalities, options, etc. (referred to above as being implemented as computer-executable instructions) based upon entered lines of programming code. The programming code may be compiled to generate an executable file. For example, a word processor may be a module that enables a text document to be created. In another example, the OS may be a module that performs a variety of services and functionalities, which may be known or unknown to the user. A programmer may enter the lines of programming code that allows for the different functionalities to be performed after the executable file is launched and being executed by the processor 105. As the functionalities are performed by the module, the module may request a portion or chunk of the memory 112 for use by the module corresponding to the computer-executable instructions. Specifically, the module may request the portion or chunk of memory 112 via the allocation module 140. The functionality associated with the allocation module 140 may be a service of the OS. Accordingly, this portion or chunk of the memory 112 may be used for immediate data retrieval, such as, e.g., storing variables declared by the functionalities of the module. For example, when the memory 112 comprises a series of chips, a portion of one of the chips may be allocated for use by the requesting module. This request may be defined by a call to a memory application programming interface (API) function in the programming code. When the region on the memory 112 is allocated to the module through this procedure, the region becomes an allocated region of the memory 112. In this manner, the allocation module 140 may allocate regions of the memory 112 where other regions of the memory 112 remain as unallocated regions. That is, the memory 112 may have an initial state where an entirety of the memory 112 is unallocated, and as modules request portions or chunks of the memory 112 for use, select regions become allocated regions and remaining regions remain unallocated regions.

According to the exemplary embodiments, the allocation module 140 may also include a functionality of generating information corresponding to the allocation of regions on the memory 112. Specifically, the information may be formatted into a scatter/gather table that tracks the regions of memory that are not allocated. For example, the scatter/gather table may be a list of the unallocated memory regions. Each entry on the list of the unallocated memory regions may also include further information that may be used by the comparator module 150 (e.g., in generating hash values or digests). With the modules of the electronic device 100 utilizing the above described mechanism of requesting chunks of the memory 112 (e.g., as a call), the scatter/gather table may correspond directly to which regions of the memory 112 are unallocated. That is, through knowledge of the regions that are allocated, the remaining regions may be determined as the unallocated regions.

The digest module 145 may receive the scatter/gather table of the unallocated regions of the memory 112 from the allocation module 140 to generate a memory surface for the memory 112. The memory surface may be a representation of the memory 112. Specifically, the memory surface may represent an overall capacity of the memory 112 with regions being allocated or unallocated. The memory surface may use the functionality provided by the allocation module 140 (e.g., use information from the allocation module 140 of the allocated regions). Therefore, when represented on a memory surface, an allocated region on the memory surface of the memory 112 may correspond to an allocated portion or chunk of memory 112 as determined by the allocation service (e.g., of the OS) of the allocation module 140.

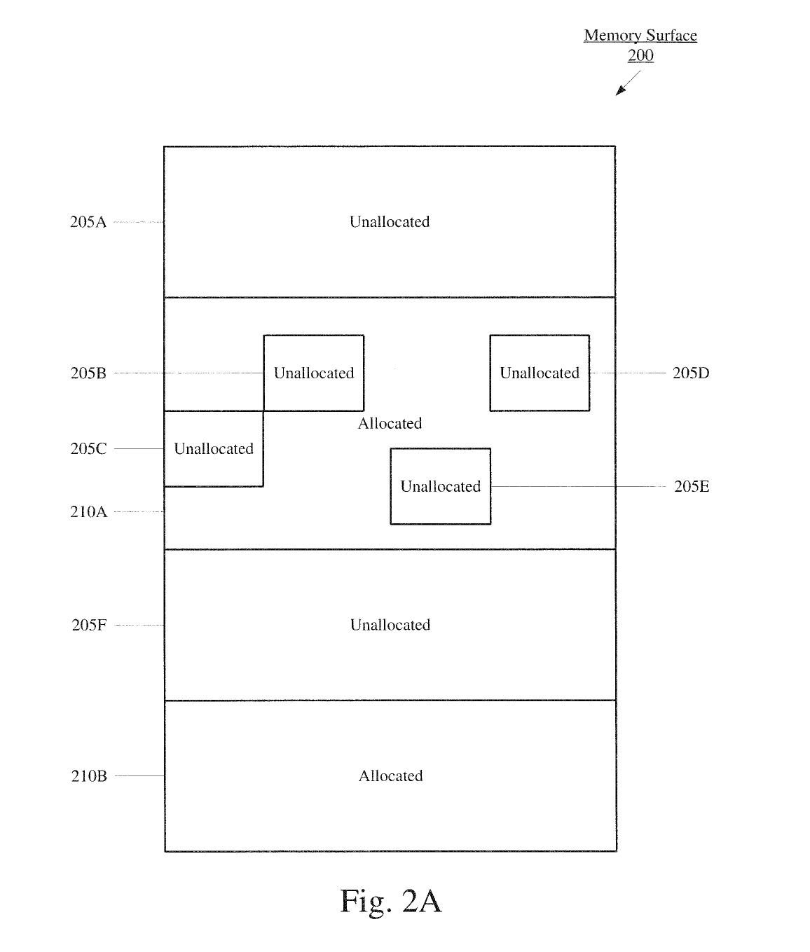

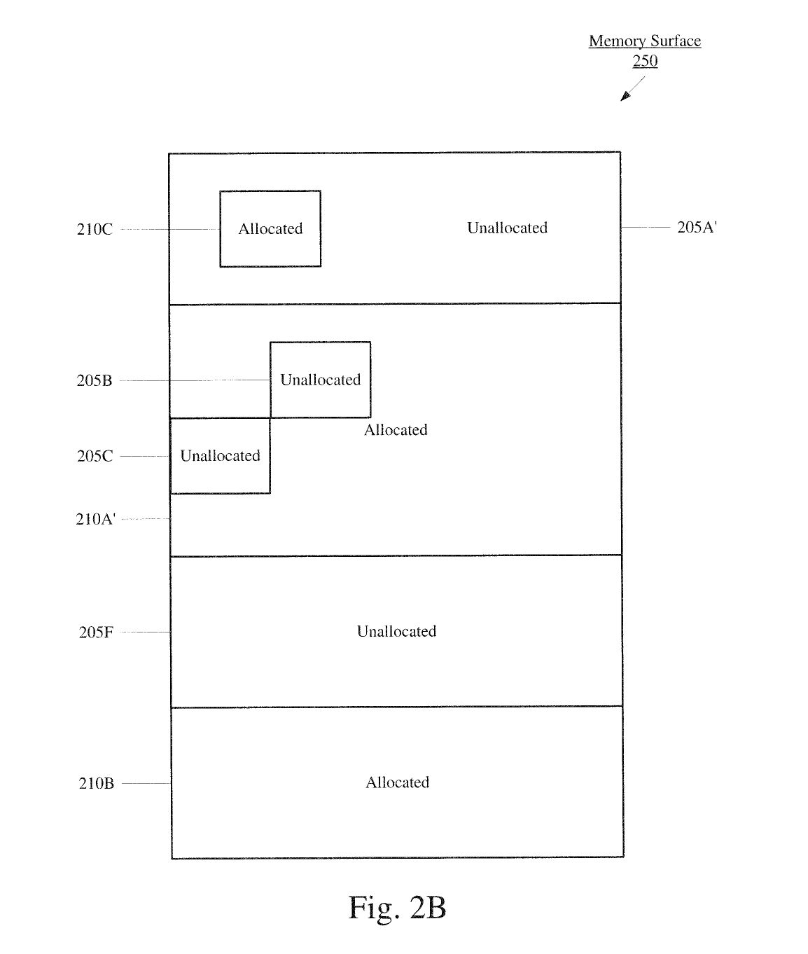

FIG. 2A shows a first memory surface 200 according to the exemplary embodiments. FIG. 2B shows a second memory surface 250 according to the exemplary embodiments. The first memory surface 200 may relate to a first state of the memory 112 when regions have been allocated, which leaves other regions as unallocated. As illustrated, the memory surface 200 may include a plurality of unallocated regions 205A-F and a plurality of allocated regions 210A-B. The second memory surface 250 may relate to a second state of the memory 112 after the first state. The second memory surface 250 may therefore have a different configuration of regions that have been allocated and other regions that have not been allocated. As illustrated, the second memory surface 250 may include a plurality of unallocated regions 205A′, B, C, F and a plurality of allocated regions 210A′, B, C. Accordingly, at some time between the first state and the second state, the unallocated regions 205D, E may have been allocated to modules by the allocation module 140, and a region within the unallocated region 205A may have been allocated as allocated region 210C by the allocation module 140.

According to an exemplary embodiment, the first state corresponding to the first memory surface 200 may be a result of a system boot of the electronic device 100. For example, the first state may be when the electronic device 100 is activated and initial modules such as the OS are executed by the processor 205. In a particular example, the first state may correspond to a system boot using a hardware driven/assisted secure boot mechanism to guarantee only a valid boot loader is executed in a trusted environment. This may ensure that the system boot of the electronic device 100 is performed as intended and as expected. For example, this may eliminate any opportunity for malicious software to be loaded in the system boot. Accordingly, this feature may be used in conjunction with the exemplary embodiments in detecting the malicious software. The system boot may entail requests for portions or chunks in the memory 112 from the OS and other modules used in the system boot. The requests for allocations may be verified for trust and loaded into the system during this phase. In this manner, the first state may be a trusted initialization state.

After the system boot is performed, the allocation module 140 may perform its functionality of initializing (e.g., generating) the scatter/gather table for the memory 112. Again, the scatter/gather table may track the unallocated regions on the memory surface based upon, for example, the regions that have been allocated from requesting modules. Thus, with respect to the first memory surface 200, the scatter/gather table may indicate the regions corresponding to the unallocated regions 205A-F. The scatter/gather table may track the unallocated regions 205A-F from the analysis of the information of allocated regions 210A-B (e.g., as provided by the allocation module 140).

Using the scatter/gather table, the digest module 145 may perform its functionality of generating a digest. In this instance, the digest that is generated may be a sealed digest. The sealed digest may represent a digest that is generated in a trusted environment or state when no malicious software has been loaded (or assumed to not have been loaded) such that the malicious software does not reside anywhere in the memory 112 (particularly in unallocated regions). As those skilled in the art will understand, the digest may represent a value that is generated based upon a function that uses the unallocated region information of the scatter/gather table. In one exemplary embodiment, the unallocated regions 205A-F and associated information (e.g., values of the chips of the memory 112 corresponding to the unallocated regions 205A-F) may be used as the basis of generating the digest. According to an exemplary embodiment, the function may be a hash function and the value may be a hash value. Specifically, the hash function may be a cryptographic hash function such as those used in the Secure Hash Algorithm 2 (SHA-2) family including, for example, 256 bits (SHA-256) or 512 bits (SHA-512).

When the secure system boot is utilized, an initial digest that is generated may be a sealed digest. Again, the sealed digest may be a digest representing a trusted state such that a detected change may be indicative of malicious software. The sealed digest may be stored, for example, as a sealed digest 155 in the storage arrangement 110. In the electronic device 100 of FIG. 1, the sealed digest 155 may be stored in the disk drive. However, the sealed digest 155 may also be stored in the memory 112. Because of how the sealed digest 155 is to be used according to the exemplary embodiments, the sealed digest 155 may reside in protected storage or a secured memory region that can only be accessed and utilized by the allocation module 140, the digest module 145, and/or the comparator module 150. Therefore, malicious software may be prevented from accessing the sealed digest 155.

After the system boot, the user may proceed with using the electronic device 100. That is, an operational state may be entered. For example, various modules may be loaded to be used (e.g., a web browser). Allocated and unallocated regions of memory 112 may be modified by various actions being performed (e.g., on the OS) or further modules being loaded and computer-executable instructions being executed. For example, regions may become allocated while previously allocated regions may become unallocated. The second memory surface 250 may represent this subsequent period after the first memory surface 200. As noted above, the second memory surface 250 may include an additional allocated region 210C while the two previously unallocated regions 205D, E may be allocated. In this manner, the allocated region 210A from the memory surface 200 may be updated to the allocated region 210A′ while the unallocated region 205A may be updated to the unallocated region 205A′.

When further actions are performed or modules are loaded (after the system boot), the allocation module 140 or some other service or functionality of the OS may verify the action/module for trust and load the action/module into the system. The allocation module 140 may also provide updated information of regions of the allocated memory that have been released. In this manner, the digest module 145 may generate a further digest with updated information in the scatter/gather table of the unallocated regions. With only trusted actions/modules being loaded, the scatter/gather table may accurately represent allowed allocations in the memory 112. Accordingly, the sealed digest 155 may be updated using the information corresponding to the second memory surface 250. That is, the first memory surface 200 may correspond to a first sealed digest and the second memory surface 250 may correspond to a second sealed digest that may be an update of the first sealed digest.

It is noted that the actions/modules may be considered to be secure or trusted e.g., a reliable request for access to memory 112, by the electronic device or processor 105 based upon a variety of factors. In a first example, the actions/modules may utilize any known security mechanism that verifies the trust of the action/module (e.g., lock and key mechanism). In a second example, the actions/modules may be determined based upon prior loading instances indicating that no malicious software was previously involved such that the actions/modules may be trusted. In a third example, the exemplary embodiments relate to detecting malicious software that does not utilize the allocation functionality of the allocation module 140, but may still reside in unallocated regions of the memory 112. In this third exemplary embodiment, the actions/modules may be determined to be trusted, e.g., not allocated to unauthorized and/or malicious software, if, at a minimum, the actions/modules utilize the allocation module 140 to request allocations.

It is also noted that the exemplary embodiments may also be utilized with actions/modules that have not been previously determined as secured or trusted. For example, a new module may initially be unknown as to trust. Thus, if the third example above is used, the new module may be subsequently determined as trusted. In another example, if the second example above is used, the new module, which has not been previous determined as secured, may initially be loaded but the exemplary embodiment may perform the mechanism of the exemplary embodiments as described in further detail below to determine if the new module is secured or trusted. Even if the new module were to utilize the allocation module 140, further mechanisms may be utilized such as conventional detection mechanisms in the allocated regions of the memory 112 to determine whether the new module includes malicious software.

It should be noted that the first and second states and the first 200 and second 250 memory surfaces are only exemplary. For example, the first 200 and second 250 memory surfaces may have different configurations or arrangements of allocated regions and unallocated regions. Furthermore, the first 200 and second 250 memory surfaces do not necessarily have to be contiguous. In another example, the first and second states may be at different times. In a first example, the first and second states may be reversed and the allocated region 210C and portions within the allocated region 210A′ may be released. In a second example, the first state may not relate to after a system boot has been performed but after significant use beyond the system boot.

According to the exemplary embodiments, the digest module 145 may generate a digest at a subsequent time. For example, the digest module 145 may generate a digest at predetermined time intervals (automatically selected or user selected), when a module has been loaded, when a region of the memory 112 has been allocated or has become unallocated (when previously allocated), a combination thereof, etc. The digest module 145 may also generate the digest relative to a previously generated sealed digest 155. The digest may therefore represent a current state within the operational state of the memory 112. The digest may be generated using a substantially similar operation discussed above. Specifically, the allocation module 140 may utilize the scatter/gather table of the current state of the memory 112 for the unallocated regions to generate the digest.

The comparator module 150 may subsequently perform its functionalities in performing a comparison of the digest of the current state with the sealed digest 155. Again, the sealed digest 155 may represent the latest sealed digest from information determined by the allocation module 140 of trusted actions/modules that have been loaded and unloaded since the system boot. Accordingly, using the above examples of the first memory surface 200 and the second memory surface 250, when the digest of the current state is generated at a time in between the first and second states, the sealed digest 155 may correspond to the first memory surface 200; whereas, when the digest of the current state is generated at a time subsequent to the second state, the sealed digest 155 may correspond to the second memory surface 250. Additional sealed digests may be generated and the corresponding sealed digest may be used by the comparator module 150 in comparing the digest.

As discussed above, the digest may represent a SHA-2 hash value that is determined from a SHA-2 hash function based upon the unallocated regions of the current state of the memory 112. The sealed digest may represent the SHA-2 hash value determined from the SHA-2 hash function based upon the unallocated regions of the previous state of the memory 112, which includes only trusted actions/modules that are loaded. Accordingly, when the comparator module 150 performs the comparison between the digest and the sealed digest and determines that the values are identical, the unallocated regions may remain unallocated and not in use by any module. An identical result of the comparison may be indicate that no malicious software has been loaded and/or resides in the unallocated regions of the memory 112. However, the comparator module 150 may determine that the unallocated regions include malicious software, if the comparison between the digest and the sealed digest indicates that the values are different. The difference between the digest and seal digest indicates that malicious software may have infiltrated the system. The comparator module 150 may report this result for subsequent actions to be performed such as an identification operation to identify the malicious software, a cleaning operation to cleanse the system of the malicious software, etc. This entire process may continue until use of the electronic device 100 has terminated.

It is noted that while the scatter/gather table and/or the sealed digest is being generated, the allocation module 140 may utilize various functionalities to hold off an allocation action. For example, a semaphore may be used to hold off allocation while the digest is generated. That is, when the digest is determined to be generated, any allocation operation that may have been requested may be paused until after the digest is generated and/or the remainder of the mechanism of the exemplary embodiments is completed.

It should also be noted that the use of the SHA-2 hash function and SHA-2 hash value is only exemplary. The exemplary embodiments may utilize any format, protocol, algorithm, mechanism, etc. that may provide a comparison functionality between a trusted state and a current state of the memory 112. For example, the exemplary embodiments may utilize any other SHA based hash function and value. In another example, the exemplary embodiments may utilize any other hash function and value such as a message-digest algorithm (MD5). Accordingly, the digest may represent any identification or parameter of the unallocated regions on the memory 112. In fact, the digest may also represent a single type of data, multiple types of data, a single piece of data, multiple data, etc.

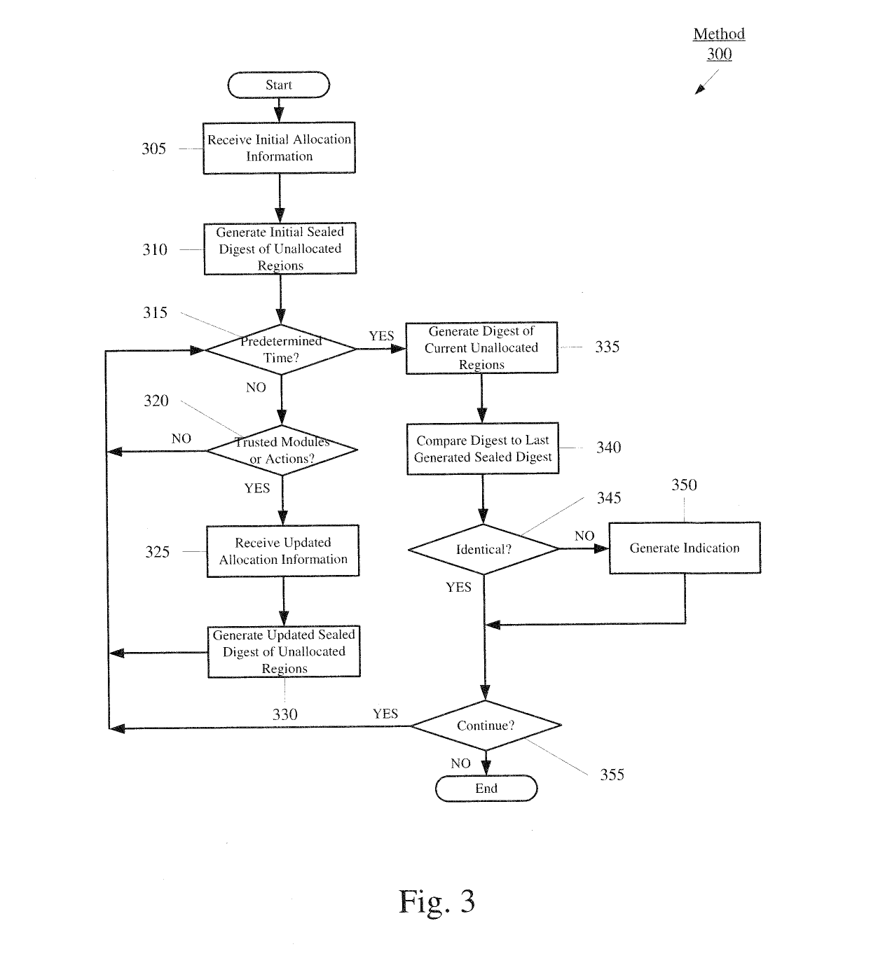

FIG. 3 shows a method 300 for detecting malicious software in unallocated memory according to the exemplary embodiments. The method 300 may relate to the operations performed by the allocation module 140, the digest module 145, and the comparator module 150. Accordingly, the method 300 will be described with regard to the electronic device 100 of FIG. 1, the first memory surface 200 of FIG. 2A, and the second memory surface 250 of FIG. 2B.

Prior to the method 300 being performed, the electronic device 100 may perform a variety of preliminary steps. In a first example, the electronic device 100 may be activated. It is noted that the activation may relate to when a system boot sequence is performed in contrast to a wake operation when a system boot is not performed. The system boot sequence may also relate to a trusted initialization state in which a secure boot mechanism is used to guarantee only a valid boot loader is executed in a trusted environment. In a second example, the system boot sequence may include one or more requests or calls for chunks in the memory 112 by modules such as the OS. Accordingly, the allocation module 140 may be used in performing this operation.

In step 305, the digest module 145 receives the initial allocation information from the allocation module 140. As described above, the allocation module 140 may allocate chunks of the memory 112 to requesting modules. The initial allocation information may relate to the allocations provided by the allocation module 140 during the system boot sequence. In an example described above, the initial allocation information may correspond to the first memory surface 200. The initial allocation information may also be included in a scatter/gather table generated by the allocation module 140 indicating the unallocated regions on the memory 112.

In step 310, the digest module 145 generates an initial sealed digest 155 of the unallocated regions on the memory 112 based upon the scatter/gather table. As discussed above, the digest may be a hash value determined using a hash function such as in SHA-2. The sealed digest 155 may be stored in the storage arrangement 110 in a protected storage to prevent any tampering, particularly from malicious software.

In step 315, the comparator module 150 determines whether the predetermined time has been reached. As discussed above, the predetermined time may be based upon a variety of factors. In a first example, the predetermined time may be based upon a time interval that may be pre-selected or user selected. In a second example, the predetermined time may be triggered based upon events such as when a module is loaded, an action is performed, a region in the memory 112 is allocated, a region in the memory is freed (i.e., becomes unallocated), etc. In a third example, the predetermined time may be a combination of the above types. If the predetermined time has not been reached, the electronic device 100 continues the method 300 to step 320.

In step 320, the allocation module 140 determines whether trusted modules are loaded and/or trusted actions are performed (which require a memory allocation). As discussed above, the modules/actions may be trusted based upon a variety of standards or mechanisms. When no trusted modules are loaded or trusted actions are performed, the electronic device 100 returns the method 300 to step 315. However, if at least one trusted module is loaded or at least one action is performed, the electronic device 100 continues the method 300 to step 325. In step 325, the allocation module 140 performs the allocation functionality and updates the scatter/gather table of the updated unallocated regions in the memory 112, which may include allocated regions have now become unallocated. Accordingly, the digest module 145 receives the updated allocation information as provided in the updated scatter/gather table. In step 330, the digest module 145 generates an updated sealed digest 155 of the unallocated regions as determined by the updated scatter/gather table. The updated sealed digest 155 may be stored in the storage arrangement 110 in protected storage. The updated sealed digest 155 may also replace the previously generated sealed digest 155. However, previously generated sealed digests may be maintained. Once the sealed digest 155 is updated, the electronic device 100 returns the method 300 to step 315. In this manner, the sealed digest 155 may be maintained in a current manner for trusted modules and trusted actions.

Returning to step 315, if it is the predetermined time, the electronic device 100 continues the method 300 to step 335. In step 335, the digest module 145 generates a digest of the current unallocated regions on the memory 112. Specifically, the digest module 145 may request a current scatter/gather table from the allocation module 140 to generate the current digest. In step 340, the comparator module 150 may receive the current digest and access the sealed digest 155 to perform a comparison. In step 345, the comparator module 150 determines whether the current digest and the sealed digest 155 are identical. If the comparison indicates that the digests are identical, the electronic device 100 continues the method 300 to step 355. However, if the comparison indicates that the digests are different, the electronic device 100 continues the method 300 to step 350. In step 350, an indication may be generated that malicious software is detected to be residing in the unallocated regions of the memory 112. As described above, the exemplary embodiments relate to a different mechanism that bypasses the allocation module 140 when malicious software is loaded and/or when malicious software resides in the memory 112. Accordingly, the mechanism of the exemplary embodiments may detect malicious software through an analysis of the unallocated regions of the memory 112.

In step 355, the electronic device 100 determines whether the user continues to utilize the electronic device 100. If the user is done using the electronic device 100, the method 300 ends. However, if the user continues to use the electronic device 100, the electronic device 100 returns the method 300 to step 315. By returning to step 315, the electronic device 100 may continue to monitor whether malicious software resides in the memory 112 as well as updating the sealed digest from the continued use of the electronic device 100.

It should be noted that the method 300 may include further steps and modifications. For example, if step 345 determines that the digest values are different and the indication is generated in step 350, the method 300 may include subsequent steps such as performing an identification operation, a cleaning operation, etc. In another example, if step 345 determines that the digest values are different and the indication is generated in step 350, the method 300 may prevent any further use of the electronic device 100 until the detected malicious software has been resolved. In a further example, the method 300 may incorporate other malicious software detection mechanisms such as those that analyze allocated regions of the memory 112.

The exemplary embodiments provide a mechanism where malicious software is detected through an analysis of unallocated regions of a memory on an electronic device. Specifically, with malicious software residing in unallocated regions on the memory without using an allocation service used by modules and actions of the electronic device, a digest of the unallocated regions are generated and compared to a sealed digest of the unallocated regions where the sealed digest is generated with known information of trusted modules and actions.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a mobile device having an operating system such as iOS, Android, etc. In a further example, the exemplary embodiments of the above described method may be embodied as a program containing lines of code stored on a non-transitory computer readable storage medium that may be executed on a processor or microprocessor.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method for detection of a malicious module using a memory of an electronic device, comprising:
generating, by the electronic device, a first parameter corresponding to first unallocated regions of the memory in a trusted state, wherein the memory in the trusted state includes at least one memory allocation, each memory allocation corresponding to a module or an action previously determined as trusted;
generating, by the electronic device, a second parameter corresponding to second unallocated regions of the memory in a current state, wherein the memory in the current state corresponds to a subsequent allocation of the memory at a time subsequent to the trusted state;
comparing, by the electronic device, the second parameter to the first parameter; and
indicating that the malicious module is detected in the second unallocated regions if the comparing step determines that the second parameter is different from the first parameter.

2. The method of claim 1, wherein the first and second parameters are digests.

3. The method of claim 2, wherein the digests are hash values generated using a hash function.

4. The method of claim 3, wherein the hash values and the hash function are based upon a Security Hash Algorithm 2 (SHA-2).

5. The method of claim 2, wherein the first parameter is a sealed digest stored in a protected storage on the memory.

6. The method of claim 1, further comprising:
prior to the comparing, determining, by the electronic device, a predetermined time from the first parameter.

7. The method of claim 6, wherein the predetermined time is one of at a predetermined time interval, upon a further module being loaded, upon a region of memory being allocated, upon a region of the memory being freed from allocation, and a combination thereof.

8. The method of claim 1, further comprising:
prior to the comparing, determining, by the electronic device, at least one of a further module and a further action that are known to be trusted having at least one further allocation on the memory; and
updating the first identification representing third unallocated regions at a further trusted state of the memory including the at least one further allocation.

9. The method of claim 1, further comprising:
generating, by the electronic device, an indication of the malicious module when the second identification is different from the first identification.

10. The method of claim 3, wherein the SHA-2 is one of 256 bits and 512 bits.

11. An electronic device, comprising:
a memory including first unallocated regions in a trusted state and second unallocated regions in a current state, the trusted state including at least one memory allocation, each memory allocation corresponding to a module or an action previously determined as trusted, the current state being at a time subsequent to the trusted state; and
a processor generating a first parameter corresponding to the first unallocated regions, the processor generating a second parameter corresponding to the second unallocated regions, the processor comparing the second parameter to the first parameter, the processor indicating that the malicious module is detected in the second unallocated regions if the comparing step determines that the second parameter is different from the first parameter.

12. The electronic device of claim 11, wherein the first and second parameters are digests.

13. The electronic device of claim 12, wherein the digests are hash values generated using a hash function.

14. The electronic device of claim 13, wherein the hash values and the hash function are based upon a Security Hash Algorithm 2 (SHA-2).

15. The electronic device of claim 12, wherein the first parameter is a sealed digest stored in a protected storage on the memory.

16. The electronic device of claim 11, wherein, prior to the comparing, the processor further determines a predetermined time from the first parameter.

17. The electronic device of claim 16, wherein the predetermined time is one of at a predetermined time interval, upon a further module being loaded, upon a region of memory being allocated, upon a region of the memory being freed from allocation, and a combination thereof.

18. The electronic device of claim 11, wherein, prior to the comparing, the processor further determines at least one of a further module and a further action that are known to be trusted having at least one further allocation on the memory and updates the first identification representing third unallocated regions at a further trusted state of the memory including the at least one further allocation.

19. The electronic device of claim 11, wherein the processor further generates an indication of the malicious module when the second identification is different from the first identification.

20. A non-transitory computer readable storage medium with an executable program stored thereon, wherein the program instructs a microprocessor to perform operations comprising:
generating a first parameter corresponding to first unallocated regions of a memory in a trusted state, wherein the memory in the trusted state includes at least one memory allocation, each memory allocation corresponding to a module or an action previously determined as trusted;
generating a second parameter corresponding to second unallocated regions of the memory in a current state, wherein the memory in the current state corresponds to a subsequent allocation of the memory at a time subsequent to the trusted state;
comparing the second parameter to the first parameter; and
indicating that the malicious module is detected in the second unallocated regions if the comparing step determines that the second parameter is different from the first parameter.
